(19) United States
(12) Patent Application Publication
(10) Pub. No.: US 2015/0006881 A1
(43) Pub. Date: Jan. 1, 2015

(54) Securing an Encryption Key of a User Device While Preserving Simplified User Experience

(71) Applicant: Check Point Software Technologies Ltd., Tel Aviv (IL)

(72) Inventors: Amnon Perlmutter, Givatayim (IL); Lior Drihem, Givat Shmuel (IL)

(21) Appl. No.: 13/928,464

(22) Filed: Jun. 27, 2013

(51) Int. Cl. H04L 9/08

(52) U.S. Cl. CPC H04L 9/0897
USPC 713/155

(57) ABSTRACT

A user device generates a key for encrypting and decrypting data of an application suite, uses a long secret to encrypt the key, and stores the key locally only as encrypted. The key is stored, along with a user-provided short secret, in a non-volatile memory of a server. Preferably, the key is generated only if an indication is received from the server that the long secret is identical to a reference long secret. The user obtains the key either by presenting the short secret to the server or by presenting the long secret to the user device to enable the user device to decrypt the encrypted key.

### FIELD AND BACKGROUND OF THE INVENTION

The present invention relates to enterprise data security and, more particularly, to a method of enabling, for an employee of an enterprise, secure and convenient use of enterprise applications on a personal device of the employee.

Mobile devices have become an essential and standard business tool that can be owned by a company or by its employees. With the rise of IT consumerization, employees are increasingly using personal devices, primarily but not limited to, smart phones and tablets, to access company resources.

The fact that company resources may be confidential due to business and regulatory requirements presents the need to encrypt the data stored on mobile devices.

There are two conventional encryption approaches:

1. Encrypt all data stored on the personal device—this is usually done at the device operating system (OS) level.

2. Secure Container/Sandbox approach—in this approach a suite of one or more applications that is/are defined as (a) business application(s) have some or all of its/their own data encrypted.

The first approach is the more suitable approach of the two for company-owned devices (usually assisted by Mobile Device Management (MDM) products). As the device is owned by the company, the company is free to force the use of a PIN code and encryption in order to allow the user to login into the device.

The second approach is more suitable for employee-owned devices (also known as “Bring Your Own Devices”—BYOD). As the devices are owned by the employees, the companies generally find it difficult to enforce security policies such as PIN codes and encryption on those devices. In this approach, the companies allow access to internal resources only from specific business applications and enforce a security policy only within the scope of those applications; the rest of such a device and its applications are not modified.

In both approaches the common practice is to encrypt the relevant data (files and/or databases and/or parts of files and/or databases) using a short secret (usually a 4 digit PIN code) that is supposed to be kept secret by the user. While this approach favors usability, the security may be compromised. If an attacker obtains physical possession of the device and wishes to crack the encryption and read the data, s/he would not find it too hard to break a short secret (for example a 4 digit password is one of just 10,000 combinations and so can be discovered, on average, in just 5000 tries).

It would be highly advantageous to have a way to keep the short secret end-user experience (at least in the common scenario) while strengthening the encryption.

The data that are secured by the present invention could be as large as entire files, directories, partitions, file systems or databases or as small as one or more single elements of data.

### SUMMARY OF THE INVENTION

The personal device of a user is referred to herein as a “user device”.

According to the present invention there is provided a method of providing secure use of an application suite on a user device, including the steps of: at the user device: (a) generating an original version of a key; (b) encrypting the original version of the key, using a long secret, thereby providing an encrypted version of the key; and (c) storing the key, in any non-volatile memory of the user device, only as the encrypted version thereof.

According to the present invention there is provided a method of providing secure use of an application suite on a user device, including the steps of: at a server: (a) establishing a communication channel with the user device; and (h) if credentials for the user are stored in a non-volatile memory of the server, the credentials including: (i) a reference short secret, and (ii) a key, then: upon receiving, from the user device, a request, for the key, that includes a short secret: sending the key to the user device only if the short secret is identical to the reference short secret.

According to the present invention there is provided a user device including: (a) at least one non-volatile memory wherein is stored: (i) computer code of an application suite, and (ii) computer code for providing secure use of the application suite by: (A) generating an original version of a key to be used for an operation selected from the group consisting of encrypting data associated with the application suite and decrypting data associated with the application suite, (B) encrypting the original version of the key, using a long secret, thereby providing an encrypted version of the key, and (C) storing the key, in any of the at least one non-volatile memory, only as the encrypted version thereof; and (b) a processor for executing the computer code.

According to the present invention there is provided a non-transient computer-readable storage medium having computer-readable code embodied on the computer-readable storage medium, the computer-readable code for providing secure use of an application suite by a user device, the computer-readable code including program code for: (a) generating an original version of a key to be used for an operation selected from the group consisting of encrypting data associated with the application suite and decrypting data associated with the application suite; (b) encrypting the original version of the key, using a long secret, thereby providing an encrypted version of the key; and (c) storing the key, in any non-volatile memory of the user device, only as the encrypted version thereof.

According to the present invention there is provided a server including: (a) a communication interface for communicating with a user device; (b) a first non-volatile memory for storing credentials of a user of an application suite on the user device, the credentials including: (i) a reference short secret, and (ii) a key; (c) a second non-volatile memory wherein is stored computer code for: upon receiving, from the user device, via the communication interface, a request, for the key, that includes a short secret: sending the key to the user device only if the short secret is identical to the reference short secret; and (d) a processor for executing the computer code.

According to the present invention there is provided a non-transient computer-readable storage medium having computer-readable code embodied on the computer-readable storage medium, the computer-readable code for assisting a server in providing secure use of an application suite by a user device, the server having a non-volatile memory for storing credentials, of a user of the user device, that include a reference short secret and a key, the computer-readable code including program code for: upon receiving, from the user device, a request, for the key, that includes a short secret: sending the key to the user device only if the short secret is identical to the reference short secret.

In a basic method of providing secure use of an application suite, of one or more applications, on a user device, an original version of a key is generated and is encrypted, using a long secret, thereby providing an encrypted version of the key. Subsequent to the encryption of the key, there is a period of time during which the key is stored in any non-volatile memory of the user device only in the encrypted form. Normally, the key is stored at the user device in unencrypted form only while actually being used to encrypt and decrypt the data of the application suite.

Preferably, before the original version of the key is generated, the user of the user device is prompted for the long secret. When the user device receives the long secret, the user device sends the long secret to a server. The original version of the key then is generated only if an indication is received from the server that the long secret is identical to a reference secret that is stored at the server. Most preferably, when the indication that the long secret is identical to the reference long secret is received, the user is prompted for a reference short secret to be stored at the server. When the user device receives the reference short secret, the user device sends the reference short secret to the server. After the user device generates the original version of the key, the user device also sends the original version of the key to the server.

Preferably, at some time while the key is being stored only in its encrypted form, the user device obtains the original version of the key and uses the original version of the key to encrypt and/or decrypt data associated with the application suite.

In one preferable manner of obtaining the original version of the key, the user device establishes a (preferably secure) communication channel with a server at which the original version of the key is stored. More preferably, the user of the user device is prompted for a short secret. When the short secret is received by the user device, the user device sends the short secret to the server. Most preferably, the user device then receives the original version of the key from the server (because the short secret that the user device has sent to the server is identical to a reference short secret that is stored at the server). If the communication channel becomes inoperative for a predetermined duration (i.e. the user is off-line for too long), the user device stops using the original version of the key for encryption and decryption. If the user wants to continue using the original version of the key for encryption and decryption, the user must enter the long secret in order to decrypt the encrypted version of the key. If the communication channel becomes inoperative for less than a (possibly different) duration (i.e. the user is off-line but not for too long), or if the user fails to interact with any application of the application suite for at least a (possibly different) duration, (for example, the user simply may have stopped using the application suite temporarily; or, if the application suite is running under an operating system that allows only one application to run in foreground, the user may have switched to an application that is not part of the application suite of the present invention) the user is prompted for the short secret. Continued use of the original version of the key for encryption and decryption then is contingent on receipt of the short secret before that predetermined duration.

If a refusal to provide the original version of the key is received from the server (which usually occurs because the short secret received from the user is not identical to the reference short secret that is stored at the server), the user device prompts the user for the long secret. Upon receiving the long secret, the user device uses the long secret to decrypt the encrypted version of the key.

When the communication channel with the server has been established, the user device may receive from the server an indication that the reference long secret that is stored at the server has been replaced with a new reference long secret. In that case, the user is prompted for a new long secret. When the user device receives the new long secret, the user device sends the new long secret to the server. Only if the user device then receives an indication from the server that the new long secret is identical to the new reference long secret, the user device uses the new long secret to encrypt the original version of the key, thereby providing a new encrypted version of the key, and stores the key, in any non-volatile memory of the user device, only as the new encrypted version of the key.

In another preferred manner of obtaining the original version of the key, the user is prompted for the long secret. When the user device receives the long secret, the user device uses the long secret to decrypt the encrypted version of the key.

In another basic method of providing secure use of an application suite on a user device, a server establishes a (preferably secure) channel of communication with the user device. If credentials of a user of the user device, which credentials include a reference short secret and a key, are stored in a non-volatile memory of the server, then upon receiving, from the user device, a request for the key, which request includes a short secret, the server sends the key to the user device only if the short secret is identical to the reference short secret. Preferably, if the short secret is different from the reference short secret, the server sends the user device a notice of refusal to send the key to the user device. Also preferably, if the server receives a predetermined number of requests for the key that include short secrets that are different from the reference short secret, the server locks the user's credentials, meaning that the user now must either replace his or her credentials (including the key) or have a system administrator unblock the existing credentials. Sending the key to the user device is contingent on the user's credentials not being locked, even if the correct short secret is received.

Preferably, the method also includes the server obtaining the credentials and storing the credentials in a non-volatile memory. More preferably, before the credentials are obtained, a reference long secret is stored in a memory of the server. The obtaining of the credentials includes requesting a long secret from the user device and, upon receipt of the long secret from the user device, requesting the credentials from the user device only if the long secret is identical to the reference long secret. Most preferably, if the server receives a predetermined number of long secrets that are different from the reference long secret, the server locks the reference long secret, which renders the reference long secret unusable by the user until a system administrator unlocks the reference long secret. Also most preferably, the method includes replacing the reference long secret with a new reference long secret. In the preferred embodiment below, in which the long secrets are AD passwords, this occurs when the server discovers that the user's AD password has changed. Typically, when the reference long secret changes, the server obtains and stores corresponding new user credentials.

The scope of the present invention also includes a user device and a server for implementing their respective methods of the present invention, and computer-readable storage media bearing computer-readable code for implementing the respective methods.

In particular, the non-volatile memory or memories of a server of the present invention serve two functions. The first function is to store user credentials. User credentials need not be always present at the server; all that is needed is that the server include a non-volatile memory that is available for storing user credentials. The second function is to store server code of the present invention. The user credentials and the server code may be stored in the same non-volatile memory or in different non-volatile memories.

### BRIEF DESCRIPTION OF THE DRAWINGS

Various embodiments are herein described, by way of example only, with reference to the accompanying drawings, wherein:

FIG. 1 is a high-level diagram of an exemplary system of the present invention;

FIG. 2 is a flowchart of how a user device of the present invention accesses and uses a key in “online mode” and in “offline mode”;

FIG. 3 is a flow chart of how a user device of the present invention stores a key and a short secret at a key management server of the present invention;

FIG. 4 is a flow chart of how a key management server of the present invention interacts with a user device of the present invention;

FIG. 5 is a high-level partial block diagram of a software-based key management server of the present invention;

FIG. 6 is a high-level partial block diagram of a software-based user device of the present invention.

### DESCRIPTION OF THE PREFERRED EMBODIMENTS

The principles and operation of enterprise security according to the present invention may be better understood with reference to the drawings and the accompanying description.

The basic idea of the present invention is to encrypt the key, that is used to encrypt the data of the relevant applications, using an encryption that would be hard for a third party to crack even if the third party had physical possession of the user device, and to store the key on the user device only in encrypted form (except while the key is being used to encrypt and decrypt data). To preserve convenience, the user is allowed to use a short secret such as a PIN to obtain the unencrypted key from a key management server.

According to the present invention the end user has two basic access modes to the encrypted data:

1. Online mode—when the user device is online—meaning that the user device is in communication with a key management server (this key management server can be located either on-premises at the company's network (or on a perimeter gateway; this “server” can actually be a cluster of servers that back up one another and/or share the load) or in the “cloud” at some other location) the user is required to provide only a short secret such as a PIN to be able to use business applications on the user device. The user thus enjoys the better end-user experience of the secure container/sandbox approach.

2. Offline mode—the user device doesn't have access to a key management server. In this mode the user is required to enter the full “long” secret that has been used to encrypt the key. As in real life the situations in which the end user device has no connectivity are becoming less common, most of the time the end user is expected to enjoy the better end user experience in which s/he is challenged to enter a short secret.

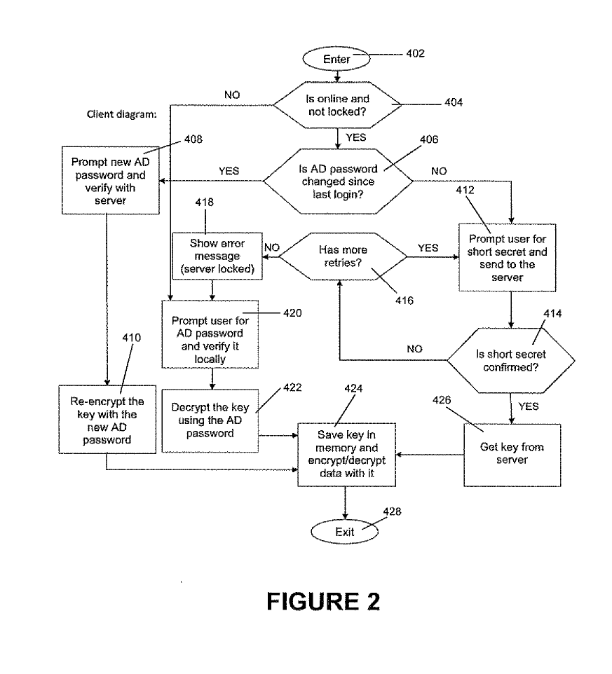

These two access modes are illustrated below in FIG. 2.

An additional and optional access mode is Online-to-Offline access mode:

3. Online-to-Offline access mode—in this mode the user activates the application that requires the secret (or accesses the entire device in case this secret is used to protect all the data that is stored in the device) while the device is online, and so has access to a key management server. Then the device goes offline, i.e., loses connectivity to the key management server. In this mode the user is required to enter only the short secret to continue working, and is not challenged by the user device to provide the full secret immediately when the device goes offline. This behavior can be managed by a policy, meaning upon the expiration of a deadline, or some other event, as configured by the enterprise's information technology administration, that happens while the device is off line, the user can be challenged to enter the full secret in order to keep using the protected applications.

The long secret can be any alphanumeric string that is too long for a third party to determine even if the third party has physical access to the user device, but the preferred example of a long secret that is used herein is an Active Directory (AD) password. In a similar way, the short secret can be any alphanumeric string that is shorter than the long secret, and the preferred example of a short secret that is used herein is a 4-digit pin code. In the appended claims, the “long secret” is any string of characters that can be entered from the keyboard, or its equivalent, of the user device. Typically, the “short secret” also is a string of characters that can be entered from the keyboard, or its equivalent, of the user device, as long as the short secret is shorter (i.e. including fewer characters) than the long secret. Alternatively, if the user device includes a touch screen, the “short secret” could be a pattern of touches of the screen that is easy for the user to remember. For example, the user device could display a regular array of dots that need to be touched selectively (i.e. touching some dots but not others) in a particular order to enter the short secret.

The first time the user runs the application or the application suite, the user is required to authenticate him/herself to the key management server with his/her AD credentials. For this purpose, the user device must be on-line the first time the user runs the application or the application suite. Once the user is authenticated, a key is generated on the user device and is encrypted by the user device using the AD password as an encryption key. Then the user is asked to select a short secret.

The short secret and the original, unencrypted key then are sent over a secure channel (for example by using the HTTPS protocol) to the key management server which saves the short secret and the unencrypted keyword, along with a time stamp, as user credentials in a user record that is dedicated to this user.

Preferably, the user records of the key management server are created and maintained on a per-user basis rather than on a per-device basis. In case a user has more than one user device with secure applications; the users' user record contains the keys to all of his/her user devices. Optionally, the user records are indexed both by user and by device.

In subsequent launches of the application or of the application suite, the following logic is applied:

When the application or application suite is launched, the application or application suite checks if the user device is online (i.e., has connectivity to the key management server).

If the user device is offline, the user is prompted to enter the long secret (in the present example, the user's AD password). If the user enters the correct password, this password is used by the user device to decrypt the encryption key that is used to encrypt/decrypt the secure data.

If the user device is online, the user is prompted for the short secret (in the present example a 4-digit pin code). The short secret is sent to the key management server along with the username of the user and (e.g. if the user has registered more than one device with the key management server) whatever other information the key management server needs to identify the proper key.

The key management server verifies that this short secret matches the short secret that was selected for this user or this user device. If the short secret that is received from the user matches the short secret that is stored for this user or user device at the key management server, the key is sent to the user device over the secure channel (e.g., via HTTPS). The user device saves the key as received (i.e., unencrypted), preferably in a volatile memory such as RAM. The user device then uses the key to encrypt/decrypt the secure data of the application or application, suite.

In order to stymie brute force attacks, the key management server locks the user after a small configurable number of wrong short secret attempts, by marking the user's record as “locked”. Once locked, the user needs to enter the long secret to become unlocked.

Under some operating systems, for example the Android™ operating system, when the user switches to a different application or to the home screen, the currently running application keeps running in background while the newly launched application, or the home screen, runs in foreground. Under such an operating system, when the application or application suite of the present invention is brought back from running in the background, entering the short secret is not always required as the system administrator can define an expiration timeout between short secret prompts. Similarly, the system administrator can define an expiration timeout for an absence of user interaction with the application or application suite. Herein, it is assumed that when the application or application suite is brought back from running in background, this expiration timeout has passed and the user is required to re-enter the short secret.

To tackle the issue of long secret changing periodically, as may be the case in the present example of the use of an AD password as the long secret, the key management server needs to check with an LDAP server or with an AD server to see if the AD password of the user has changed since the last time the user supplied the short secret. If the AD password has changed, the key management server asks the user device to send the new AD password (even though the user device is online), in order to confirm the validity of the user credentials, and the user device needs to re-encrypt the key with the new AD password. If the alleged new AD password that the key management server receives from the user device is not identical to the new AD password that is stored at the LDAP server or at the AD server then the key management server locks the user's record.

If the AD password has changed but the client is offline (hasn't been online since the AD password has changed), the user enters the old AD password in order to work in offline mode. The old AD password is used for working in offline mode until the next time the user works in online mode, at which time the key management server will request the new AD password as described above. Subsequently, the user will use the new AD password for working in offline mode.

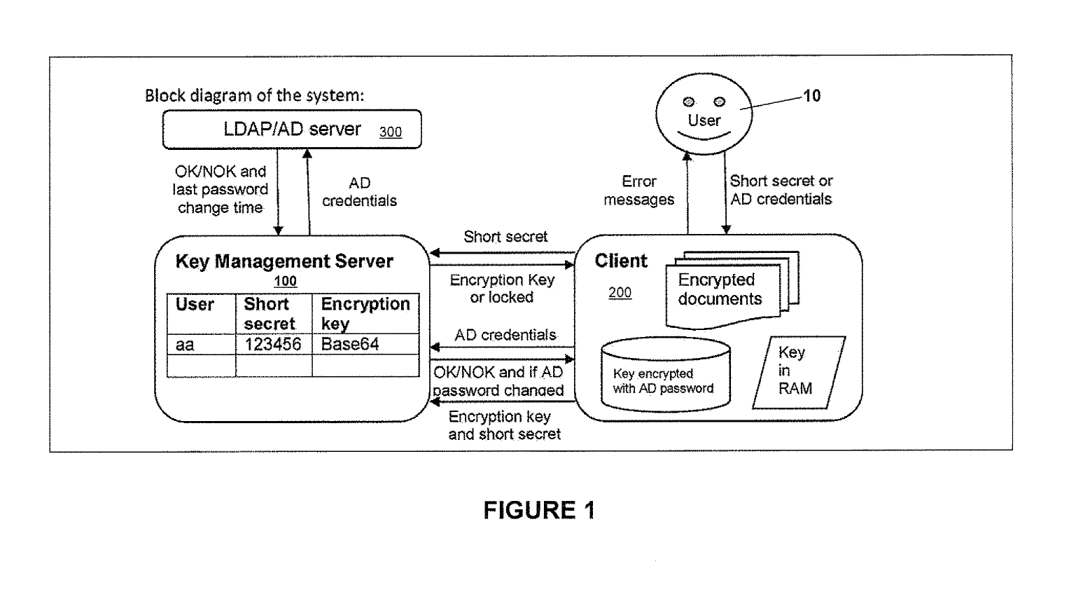

In the appended claims, the unencrypted key at the user device is generally called the “original” key. The short secret as stored at the key management server is generally called the “reference” short secret. The long secret as stored at whatever server is used to store the long secret is generally called the “reference” long secret. The scope of the term “server” in the appended claims includes all the servers needed to implement the invention, including, in the preferred example, LDAP/AD server 300 of FIG. 1 in the usual case that copies of the AD passwords are not stored locally at key management server 200 of FIG. 1.

FIG. 1 is a high-level diagram of an exemplary system of the present invention. The system includes a user device (“Client”) 200 of a user 10, a key management server 100 and a LDAP/AD server 300, that exchange data and messages as shown.

FIG. 2 is a flowchart of how user device 200 accesses and uses the unencrypted key in “online mode” and in “offline mode”, after the key and the short secret have been saved at key management server 100. After the application or application suite is launched (402), the application or application suite checks (404) that user device 200 is on-line, and checks with; key management server 100 that (404) user device 200 has not been locked by key management server 100 and, if user device 200 has not been locked by key management server 100, that (406) the long secret (in this example, an AD password) is up-to-date. If the long secret is up-to-date, key management server 100 prompts user 10 (412) for the short secret. User 10 is allowed a small number of tries (414, 416) to enter the correct short secret. If the correct short secret is entered, key management server 100 sends (426) the unencrypted key to user device 200. The application or application suite receives (426) the key from key management server 100, stores (424) the key locally (preferably in RAM so that the key does not remain on user device 200 after user device 200 is shut off) and uses (424) the key to encrypt and decrypt sensitive data.

If user 10 fails to enter the correct short key, an error message is displayed (418), key management server 100 locks (418) this user's account, and the application or application suite prompts user 10 (420) for the long secret. Upon receiving the long secret from user 10, the application or application suite uses the long secret (422) to decrypt the local encrypted copy of the key and uses the decrypted key (424) to encrypt and decrypt sensitive data.

If the long secret is not up-to-date, key management server 100 instructs user device 200 to prompt user 10 (408) for the new long secret. Upon receipt of the new long secret from user 10, the new long secret is used (410) to encrypt the local unencrypted copy of the key and the unencrypted key is used (424) to encrypt and decrypt sensitive data.

If user device 200 is not on-line, the application or application suite prompts user 10 (420) for the long secret. Upon receiving the long secret from user 10, the application or application suite uses the long secret (422) to decrypt the local encrypted copy of the key and the decrypted key is used (424) to encrypt and decrypt sensitive data.

When user 10 is finished (for now) with the secure data, user 10 exits (428) the key access procedure.

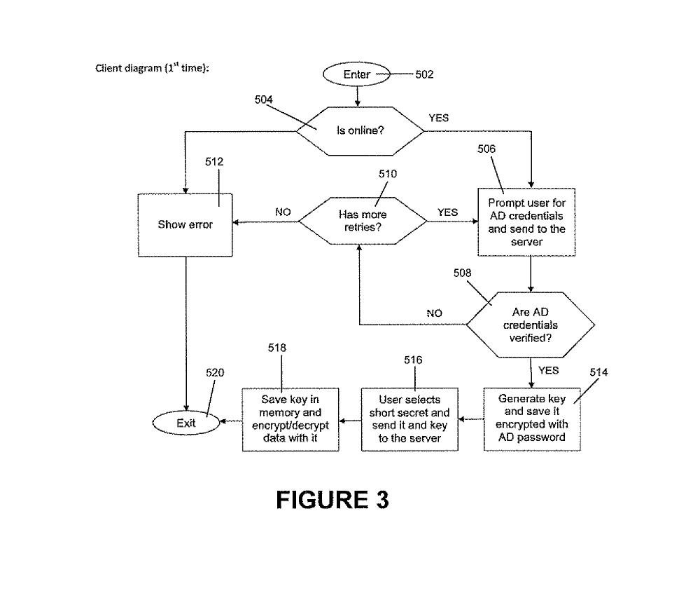

FIG. 3 is a flow chart of how user device 200 saves the key and the short secret at key management server 100. After the application or application suite is initiated (502), the application or application suite checks (504) that user device 200 is on-line. If user device 200 is on-line, the application or application suite prompts user 10 (506) for his/her AD credentials including the AD password of user 10. In the present example, the AD password of user 10 is used as the long secret. User 10 is allowed a small number of tries (508, 510) to enter the correct AD credentials. User device 200 sends the AD credentials to key management server 100. If the AD credentials are validated by key management server 200 in consultation with LDAP/AD server 300, key management server 100 notifies user device 200 of the successful validation. The application or application suite generates a key (514) and uses the AD password of user 10 to encrypt the key. The application or application suite stores the encrypted key locally in non-volatile memory. User 10 selects and enters (516) a short secret. The application or application suite sends the short secret and the (unencrypted) key to key management server 100. Optionally, user 10 may now use (518) the unencrypted key, now preferably stored only in RAM, to encrypt and decrypt sensitive data. With the short secret and the unencrypted key now stored at key management server 100, the application or application suite exits (520).

If user device 200 is not on-line, or if user 10 fails to enter the correct AD credentials, an error message is generated (512) and the application or application suite exits (520).

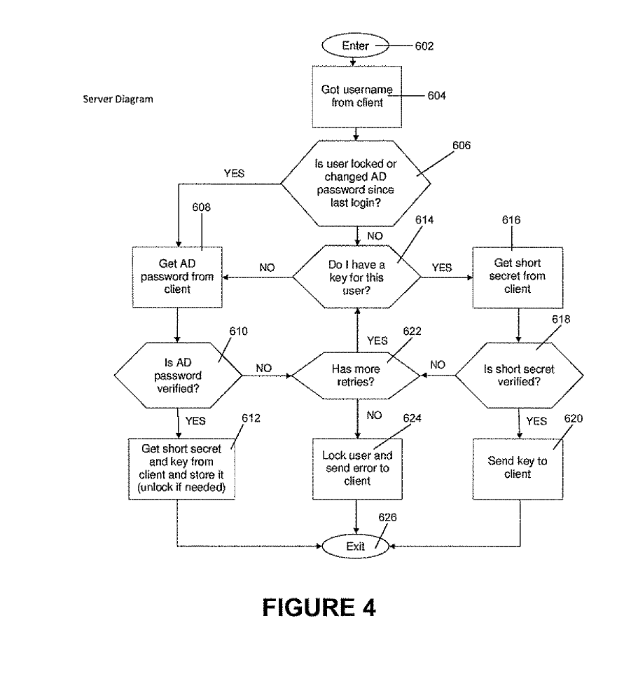

FIG. 4 is a flow chart of how key management server 100 interacts with user device 200. Starting at 602, key management server 100 receives (604) a login request, from user device 200, that includes an identification, such as a user name, of user 10. If this user 10 has been locked, or if, according to LDAP/AD server 300, the AD password of this user 10 has been changed since the last login request of this user 10 (606), then the new AD password is obtained (608) from user device 200. If LDAP/AD server 300 verifies (610) the alleged new AD password that has been received from user device 200, then a short secret and a key are obtained (612) from user device 200 and are stored locally in non-volatile memory in association with the identification of this user 10. In addition, if the account of this user 10 has been locked, the account is unlocked.

If this user 10 is not locked and, according to LDAP/AD server 300, the AD password of this user 10 is up-to-date, key management server checks (614) for a local record of a key associated with the identification of this user 10. If such a record does not exist, the AD password of user 10 is obtained (608) from user device 200. If LDAP/AD server 300 verifies (610) the alleged AD password that has been received from user device 200, then a short secret and a key are obtained (612) from user device 200 and are stored locally in non-volatile memory in association with the identification of this user 10.

If a local record of a key associated with the identification of this user 10 does exist, the short secret of this user 10 is obtained (616) from user device 200. User 10 is allowed (618, 622) a small number of tries to provide the correct short secret. Upon receipt of the correct short secret, the key of this user 10 is sent (620) to user device 200. Otherwise (624), the account of this user 10 is locked and user device 200 is notified that the account of this user 10 has been locked.

The interaction of key management server 100 with user device 200 ends at 626.

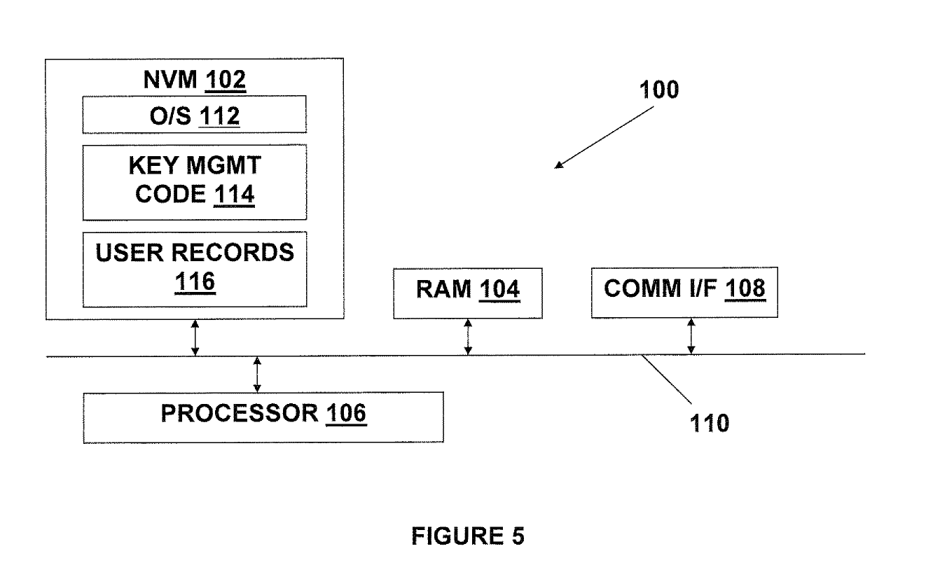

FIG. 5 is a high-level partial block diagram of a software-based key management server 100 of the present invention. For clarity of illustration, only the components of key management server 100 that are relevant to the present invention are shown in FIG. 5. Key management server 100 includes a non-volatile memory (NVM) 102, a random access memory (RAM) 104, a processor 106, and a standard wired and/or wireless communication interface 108 for communicating with user device 200 and LDAP/AD server 300, all communicating with each other via a bus 110. An operating system (O/S) 112 of key management server 100 is stored in NVM 102, as is key management code 114 and a set 116 of user records for implementing the key-management-server side of the present invention as described above. Under the control of O/S 112, processor 106 loads key management code 114 into RAM 104 and executes key management code 114 from RAM 104. As keys and short secrets of users 10 are received from user devices 200, these keys and short secrets are stored in user records 116. Upon receipt of a valid short secret from a user device 200 via communication interface 108, the associated key is returned to that user device 200 via communication interface 108. As necessary, user records 116 are locked and unlocked as described above.

In the example of FIG. 5, key management code 114 and user records 116 are stored in the same non-volatile memory 102. Alternatively, key management code 114 and user records 116 are stored in separate non-volatile memories of key management server 100.

NVM 102 is an example of a computer-readable storage medium bearing computer-readable code for implementing the key-management-server-side methodology described herein. Other examples of such computer-readable storage media include read-only memories such as CDs bearing such code.

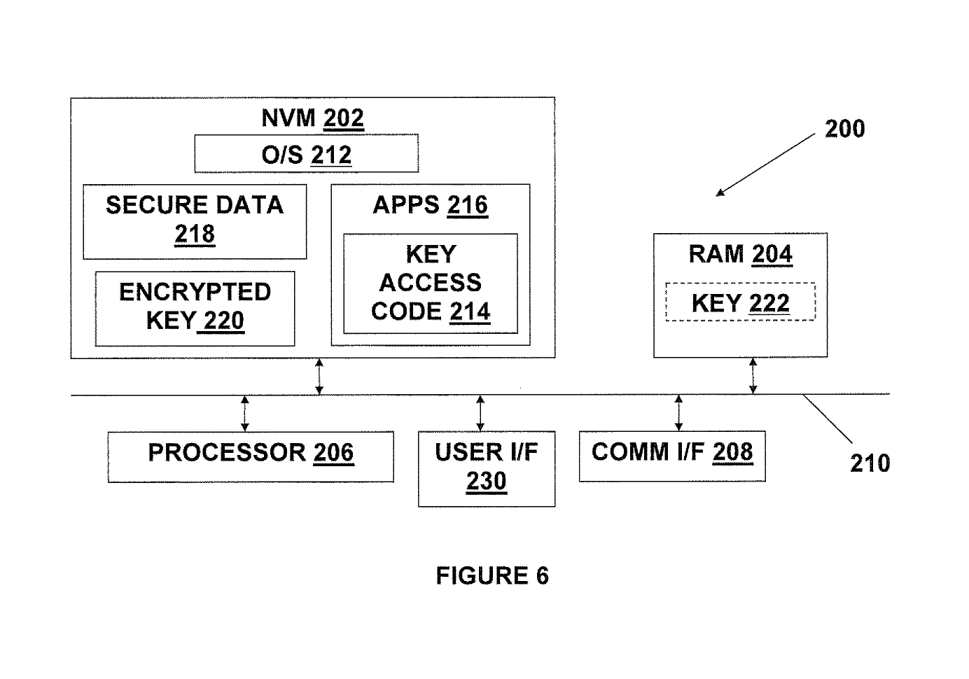

FIG. 6 is a high-level partial block diagram of a software-based user device 200 of the present invention. For clarity of illustration, for the most part, only the components of user device 200 that are relevant to the present invention are shown in FIG. 6. User device 200 includes a NVM 202, a RAM 204, a processor 206, a standard wired and/or wireless communication interface 208 for communicating with key management server 100, and user interface components 230, all communicating with each other via a bus 210. If user device 200 is a personal computer then communication interface 208 could be either a wired communication interface or a wireless communication interface, and user interface components 230 typically include a keyboard, a display screen, a mouse and a printer. If user device 200 is a smart phone or a tablet, user interface components 230 typically include a touch screen, a microphone and a speaker.

In NVM 202 are stored an O/S 212, code 216 of the application or application suite whose data 218 are to be encrypted and decrypted with the key, data 218 themselves, and the key as encrypted using the long secret (“encrypted key 220”). Code 216 includes user code 214 of the present invention for storing the unencrypted key at key management server 100 as described above and for obtaining and using the key in one of the three modes (online, offline, online-to-offline) described above. Under the control of O/S 212, processor 206 loads application or application suite code 216 into RAM 204 and executes application or application suite code 216, including user code 214 of the present invention, in RAM 204.

When in use the (unencrypted) key is stored temporarily in a memory location 222 in RAM 204. That key 222 thus stored is ephemeral is indicated in FIG. 6 by the dashed border of the box that encloses key 222. Alternatively, the unencrypted key could be stored in NVM 202; the benefit of storing the unencrypted key in RAM 204 is that the unencrypted key so stored is erased automatically when user device 200 is shut off.

NVM 202 is an example of a computer-readable storage medium bearing computer-readable code for implementing the user-device-side methodology described herein. Other examples of such computer-readable storage media include read-only memories such as CDs bearing such code.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method of providing secure use of an application suite on a user device, comprising the steps of: at the user device:
(a) generating an original version of a key;
(b) encrypting said original version of said key, using a long secret, thereby providing an encrypted version of said key; and
(c) storing said key, in any non-volatile memory of the user device, only as said encrypted version thereof.

2. The method of claim 1, further comprising the steps of: prior to said generating:
(d) prompting a user of the user device for said long secret; and
(e) upon receipt of said long secret: sending said long secret to a server;
and wherein said generating is contingent on receiving, from said server, an indication that said long secret is identical to a reference long secret that is stored at said server.

3. The method of claim 2, further comprising the steps of: upon receiving, from said server, said indication that said long secret is identical to said reference long secret:
(f) prompting said user for a reference short secret;
(g) upon receipt of said reference short secret, sending said reference short secret to said server; and
(h) subsequent to said generating, sending said original version of said key to said server.

4. The method of claim 1, further comprising the steps of:
(d) subsequent to said storing, obtaining said original version of said key; and
(e) using said original version of said key for an operation selected from the group consisting of encrypting data associated with the application suite and decrypting data associated with the application suite.

5. The method of claim 4, wherein said obtaining is effected by steps including:
(i) establishing a communication channel with a server whereat said original version of said key is stored.

6. The method of claim 5, wherein said obtaining is effected by steps further including:
(ii) prompting a user of the user device for a short secret, and
(iii) upon receipt of said short secret, sending said short secret to said server.

7. The method of claim 6, wherein said obtaining is effected by steps further including:
(iv) receiving said original version of said key from said server.

8. The method of claim 7, further comprising the step of:
(f) if said communication channel becomes inoperative for a predetermined duration: ceasing said using of said original version of said key.

9. The method of claim 7, further comprising the step of:
(f) if said communication channel becomes inoperative for less than a predetermined duration: prompting said user for said short secret, continuation of said using of said original version of said key being contingent on receipt of said short secret before said predetermined duration.

10. The method of claim 7, further comprising the step of:
(f) if the user fails to interact with any application of the application suite for at least a predetermined duration: prompting said user for said short secret, continuation of said using of said original version of said key being contingent on receipt of said short secret.

11. The method of claim 6, wherein said obtaining is effected by steps further including: upon receiving from said server a refusal to provide said original version of said key:
(iv) prompting said user for said long secret, and
(v) upon receipt of said long secret, using said long secret to decrypt said encrypted version of said key.

12. The method of claim 5, further comprising the steps of: upon receiving from said server an indication that a reference long secret that is stored at said server has been replaced with a new reference long secret:
(f) prompting a user of the user device for a new long secret;
(g) upon receipt of said new long secret, sending said new long secret to said server; and
(h) only upon receiving from said server an indication that said new long secret is identical to said new reference long secret:
(i) encrypting said original version of said key, using said new long secret, thereby providing a new encrypted version of said key, and
(ii) storing said key, in any non-volatile memory of the user device, only as said new encrypted version thereof.

13. The method of claim 4, wherein said obtaining is effected by steps including:
(i) prompting said user for said long secret, and
(ii) upon receipt of said long secret, using said long secret to decrypt said encrypted version of said key.

14. A method of providing secure use of an application suite on a user device, comprising the steps of: at a server:
(a) establishing a communication channel with the user device; and
(b) if credentials for a user of the user device are stored in a non-volatile memory of said server, said credentials including:
(i) a reference short secret, and
(ii) a key,
then: upon receiving, from the user device, a request, for said key, that includes a short secret: sending said key to the user device only if said short secret is identical to said reference short secret.

15. The method of claim 14, further comprising the step of:
(c) if said short secret is different from said reference short secret: sending the user device a notice of refusal to send said key to the user device.

16. The method of claim 14, further comprising the steps of:
(c) upon receipt of a predetermined number of said requests that include a short secret that is different from said reference short secret: locking said credentials.

17. The method of claim 14, further comprising the steps of:
(c) obtaining said credentials; and
(d) storing said credentials in said non-volatile memory of said server.

18. The method of claim 17, further comprising the step of:
(d) prior to obtaining said credentials, storing a reference long secret in a memory of said server;
and wherein said obtaining is effected by steps including:
(i) requesting a long secret from the user device,
(ii) upon receipt of said long secret from the user device: only if said long secret is identical to said reference long secret: requesting said credentials from the user device.

19. The method of claim 18, further comprising the step of:
(e) upon receipt of a predetermined number of instances of said long secret that are different from said reference long secret: locking said reference long secret.

20. The method of claim 18, further comprising the step of:
(e) replacing said reference long secret with a new reference long secret.

21. The method of claim 20, wherein said obtaining and storing are effected in response to said replacing.

22. A user device comprising:
(a) at least one non-volatile memory wherein is stored:
(i) computer code of an application suite, and
(ii) computer code for providing secure use of said application suite by:
(A) generating an original version of a key to be used for an operation selected from the group consisting of encrypting data associated with said application suite and decrypting data associated with said application suite,
(B) encrypting said original version of said key, using a long secret, thereby providing an encrypted version of said key, and
(C) storing said key, in any of said at least one non-volatile memory, only as said encrypted version thereof; and
(b) a processor for executing said computer code.

23. A non-transient computer-readable storage medium having computer-readable code embodied on the computer-readable storage medium, the computer-readable code for providing secure use of an application suite by a user device, the computer-readable code comprising program code for:
(a) generating an original version of a key to be used for an operation selected from the group consisting of encrypting data associated with the application suite and decrypting data associated with the application suite;
(b) encrypting said original version of said key, using a long secret, thereby providing an encrypted version of said key; and
(c) storing said key, in any non-volatile memory of the user device, only as said encrypted version thereof.

24. A server comprising:
(a) a communication interface for communicating with a user device;
(b) a first non-volatile memory for storing credentials of a user of an application suite on said user device, said credentials including:
(i) a reference short secret, and
(ii) a key;
(c) a second non-volatile memory wherein is stored computer code for: upon receiving, from the user device, via said communication interface, a request, for said key, that includes a short secret: sending said key to the user device only if said short secret is identical to said reference short secret; and
(d) a processor for executing said computer code.

25. A non-transient computer-readable storage medium having computer-readable code embodied on the computer-readable storage medium, the computer-readable code for assisting a server in providing secure use of an application suite by a user device, the server having a non-volatile memory for storing credentials, of a user of the user device, that include a reference short secret and a key, the computer-readable code comprising program code for: upon receiving, from the user device, a request, for said key, that includes a short secret: sending said key to the user device only if said short secret is identical to said reference short secret.
